(19) United States
(12) Patent Application Publication
(10) Pub. No.: US 2010/0199305 A1
(43) Pub. Date: Aug. 5, 2010

(54) IPTV DIGITAL-BROADCAST SYSTEM AND METHOD FOR REDUCING CHANNEL CHANGE TIME

(75) Inventors: Sang Hyeun Lee, Gwangju (KR); Byung Tak Lee, Suwon (KR); Sim Kwon Yoon, Gwangju (KR); Ho Young Song, Daejeon (KR); Bong Tae Kim, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Institute, Daejeon (KR)

(21) Appl. No.: 12/680,179

(22) PCT Filed: Feb. 27, 2008
(86) PCT No.: PCT/KR08/01136

§ 371 Date: Mar. 25, 2010

(30) Foreign Application Priority Data
Sep. 27, 2007 (KR) 10-2007-0097488

(51) Int. Cl. G06F 13/14; H04N 7/173

(52) U.S. Cl. 725/38; 725/110

(57) ABSTRACT

There is provided a IPTV digital broadcast system and method capable of reducing a channel change time, the system including: an IPTV providing server providing a broadcast stream including broadcast data for each channel; an EPG server, when a client terminal accesses, providing an EPG, multicast group information for each channel, and PID information for each channel to the client terminal; and a PID providing server acquiring the PID information for each channel itself and providing the PID information for each channel to the EPG server.

### TECHNICAL FIELD

The present invention relates to an IPTV digital-broadcast system, and more particularly, to an IPTV digital-broadcast system and method for reducing a delay time occurring when changing a channel of a client terminal.

### BACKGROUND ART

IPTV digital broadcast has a lot of merits such as providing various and high quality services in comparison with analog broadcast. However, there is a demerit of consuming a lot of channel change time.

Generally, channel change delays of the IPTV digital broadcast may be divided into a network delay, a broadcast stream decoding delay, and a buffering delay for adapting to a broadcast stream jitter.

Particularly, the broadcast stream decoding delay may be divided into a delay for detecting a packet ID (PID) information of a desired channel and a delay for detecting an I-frame. The present invention relates to a method of reducing the delay for detecting the PID information.

FIG. 1 is a configuration diagram illustrating a general broadcast stream.

Referring to FIG. 1, a broadcast stream of an IPTV is according to a motion picture experts group transport stream (MPEG-TS). Accordingly, the broadcast stream is formed of broadcast data for each channel, and a program association table (PAT) and a program map table (PMT) inserted by a predetermined period. The broadcast data for each channel is formed of an audio packet, a video packet, and other information. Each PID is allocated for each kind of packets.

In the PAT, the PID of the PMT corresponding to each channel is stored. In the PMT, PIDs of each packet forming the broadcast data for each channel are stored.

For example, as shown in FIG. 1, in the PAT, “CH1=15, CH2=150, and Ch3=311”, which are PMT PIDs of channels 1, 2, and 3, are stored. In a PMT corresponding to the channel 1, “video=51, audio=64, and subtitle=101”, which are PIDs of a video packet, an audio packet, and a title packet forming broadcast data of the channel 1, are stored.

A receiving terminal of the broadcast stream may extract PID information of a desired channel from the broadcast stream and extract and replay broadcast data of a changed channel referring to the extracted PID information.

FIG. 2 is a flowchart illustrating a conventional method of decoding a broadcast stream, performed by a client terminal receiving the broadcast stream.

The client terminal acquires a PAT by searching inputted broadcast stream (S11) and extracts PIDs of a PMT corresponding to a desired channel (S12).

The PMT having the extracted PIDs is acquired (S13), PIDs of packets forming broadcast data of the channel are extracted (S14), and the packets having the extracted PIDs, such as a video packet, an audio packet, and other packets, are acquired and decoded (S15).

However, since a series of processes of searching required PID information by sequentially searching PAT and PMT as shown in FIG. 2 consumes a relatively lot of time, there may be a delay in a PID information detection time.

FIG. 3 is a flowchart illustrating a conventional method of changing a channel of an IPTV digital broadcast system. In this case, the IPTV digital broadcast system includes an IPTV providing server 110, an electronic program guide (EPG) server 120, one or more routers 130, and one or more client terminals 140.

The client terminal 140 accesses the EPG server 120 to receive services with respect to IPTV digital broadcast (S21). The EPG server 120 provides an EPG and multicast group information for each channel to the client terminal 140 (S22).

When a user of the client terminal 140 changes a channel by using the EPG (S23), the client terminal 140 acquires multicast group information corresponding to the changed channel by searching the provided multicast group information for each channel (S24) and request joining a multicast group corresponding to the changed channel based on the acquired multicast group information (S25).

The router 130 allows the client terminal 140 to join the multicast group in response to the requesting and copies and provides a broadcast stream of the requested multicast group to the client terminal 140 (S26 and S27).

The client terminal 140 receiving the broadcast stream detects PID information of the changed channel from the received broadcast stream as shown in FIG. 2 (S28) and decodes the broadcast stream by using the detected PID information (S29).

As described above, the PID information detecting method of FIG. 2 requires that a broadcast stream is provided, information required in direct decoding is acquired from the provided broadcast stream, and the broadcast stream is requested to be provided and is decoded by using the acquired information.

### DISCLOSURE OF INVENTION

### Technical Problem

However, in the conventional channel change method as described above, it is required to acquire the information required in decoding from a broadcast stream, a decoding time is unavoidably delayed and a channel change speed is also decreased.

### Technical Solution

According to an aspect of the present invention, there is provided a client terminal including: a service information receiver receiving multicast group information for each channel and PID (packet identification) information for each channel, transmitted from an IPTV (Internet protocol television) network; a channel changer, when a channel is changed, acquiring multicast group information of the changed channel from the multicast group information for each channel and joining a multicast group; a PID searcher, when a channel is changed, searching the PID information for each channel and acquiring PID information of the changed channel; and a decoder, when a broadcast stream transmitted to the multicast group is received, decoding the broadcast stream via the PID information of the changed channel.

The client terminal may further include a PID detector detecting the PID information by analyzing the broadcast stream. In this case, when the PID receiver abnormally operates, the decoder may decode the broadcast stream via the PID information detected by the PID detector.

The PID information for each channel may include one or more of a video PID, an audio PID, a DRM (digital rights management) PID, a CAS (conditional access system) PID, PID on EMM (entitlement management messages) and ECM (entitlement control message) of a CAS, and other options PID, which correspond to each of a plurality of channels and form the correspondent channel.

According to another aspect of the present invention, there is provided a PID providing server including: a PID auto detector joining an IPTV network, acquiring a broadcast stream, and detecting PID information for each channel from the broadcast stream; a PID manual input unit for manually inputting the PID information for each channel; and a PID provider providing the PID information for each channel acquired by one of the PID auto detection and the PID manual input unit, to an EPG (electronic program guide) server.

The PID auto detector may include: a broadcast stream acquisition unit joining a multicast group in the IPTV network and acquiring the broadcast stream; and a PID detection unit detecting the PID information by analyzing the broadcast stream.

The PID provider, whenever a setting period comes or the PID information for each channel is changed, may reacquire the PID information for each channel and retransmit the PID information to the EPG server.

The PID information for each channel may include one or more of a video PID, an audio PID, a DRM PID, a CAS PID, PID on EMM and ECM of a CAS, and other options PID, which correspond to each of a plurality of channels and form the correspondent channel.

According to still another aspect of the present invention, there is provided a An IPTV digital broadcast system including: an IPTV providing server providing a broadcast stream including broadcast data for each channel; an EPG server, when a client terminal accesses, providing an EPG, multicast group information for each channel, and PID information for each channel to the client terminal; and a PID providing server acquiring the PID information for each channel itself and providing the PID information for each channel to the EPG server.

The PID providing server may include: a PID auto detector joining an IPTV network, acquiring a broadcast stream, and detecting PID information for each channel from the broadcast stream; a PID manual input unit for manually inputting the PID information for each channel; and a PID provider providing the PID information for each channel acquired by one of the PID auto detection and the PID manual input unit, to an EPG (electronic program guide) server.

The PID provider, whenever a setting period comes or the PID information for each channel is changed, may reacquire the PID information for each channel and retransmit the PID information to the EPG server.

According to yet another aspect of the present invention, there is provided a method of changing a channel of an IPTV digital broadcast system formed of an IPTV providing server, a service information providing server, and a client terminal, the method including: providing multicast information for each channel and PID information for each channel when sensing an access of the client terminal, performed by the service information providing server; acquiring multicast information and PID information of a changed channel from the multicast information for each channel and the PID information for each channel when a channel is changed, performed by the client terminal; requesting receiving a broadcast stream provided by the IPTV providing server via the multicast information of the changed channel, performed by the client terminal; and receiving and decoding the broadcast stream via the PID information of the changed channel, performed by the client terminal.

The providing multicast information for each channel and PID information for each channel may include: acquiring the PID information for each channel; and providing the PID information for each channel together with the multicast group information for each channel.

The acquiring the PID information for each channel may include: joining the IPTV network and acquiring the broadcast stream; and detecting the PID information for each channel by analyzing the broadcast stream. The acquiring the PID information for each channel may further include reacquiring the broadcast stream and redetecting and retransmitting the PID information for each channel whenever a setting period comes. The acquiring the PID information for each channel may further include manually inputting the PID information for each channel and retransmitting the PID information for each channel when the PID information for each channel is changed.

The PID information may include one or more of a video PID, an audio PID, a DRM PID, a CAS PID, PID on EMM and ECM of a CAS, and other options PID, which correspond to each of a plurality of channels and form the correspondent channel.

### Advantageous Effects

As described above, according to the IPTV digital broadcast system and method for reducing an amount of time of changing a channel, a client terminal previously receives PID information of channels required in changing a channel, thereby directly acquiring PID information of a changed channel and decoding a broadcast stream.

### BRIEF DESCRIPTION OF THE DRAWINGS

FIG. 1 is a diagram illustrating a configuration of a general broadcast stream;

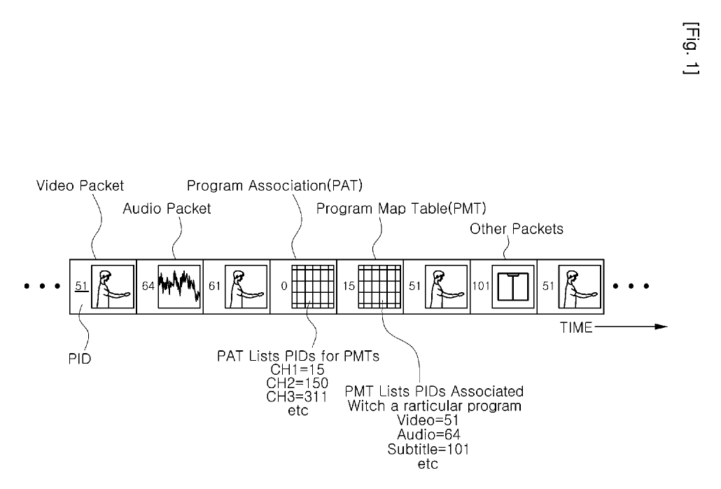

FIG. 2 is a flowchart illustrating a conventional method of decoding a broadcast stream;

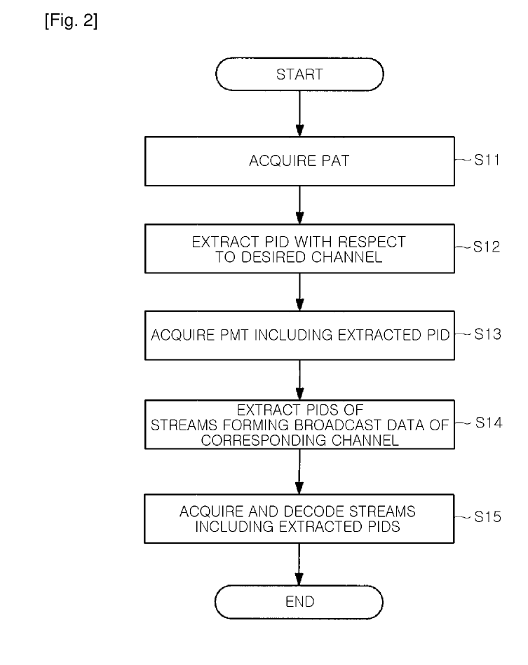

FIG. 3 is a flowchart illustrating a conventional method of changing a channel of an Internet protocol television (IPTV) digital broadcast system;

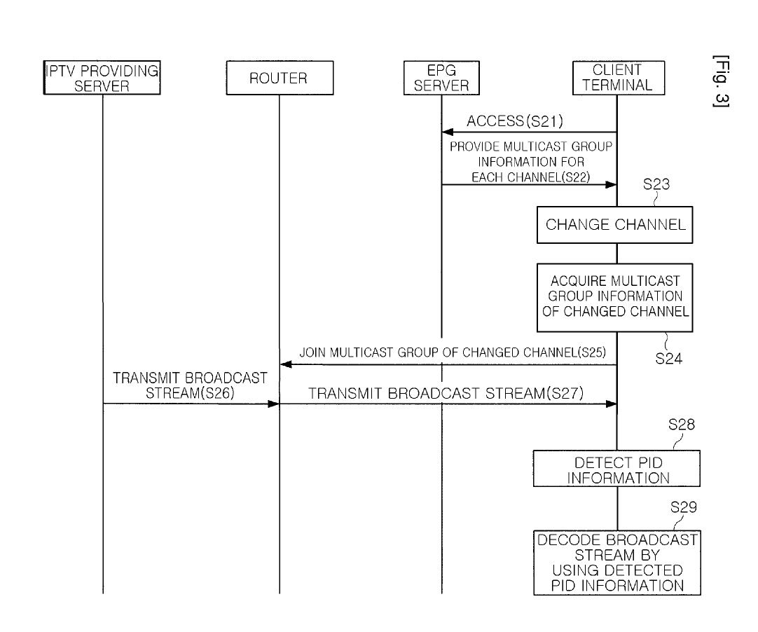

FIG. 4 is a configuration diagram illustrating an IPTV digital broadcast system for reducing a channel change time, according to an exemplary embodiment of the present invention;

FIG. 5 is a configuration diagram illustrating a packet identification (PID) providing server according to an exemplary embodiment of the present invention;

FIG. 6 is a detailed configuration diagram illustrating a client terminal according to an exemplary embodiment of the present invention;

FIG. 7 is a flowchart illustrating a method of providing PID information in the PID providing server, according to an exemplary embodiment of the present invention;

FIG. 8 is a flowchart illustrating a decoding method in the client terminal, according to an exemplary embodiment of the present invention; and

FIG. 9 is a flowchart illustrating a method of changing a channel in the IPTV digital broadcast system, according to an exemplary embodiment of the present invention.

### BEST MODE FOR CARRYING OUT THE INVENTION

Exemplary embodiments of the present invention will now be described in detail with reference to the accompanying drawings. Only, in describing operations of the exemplary embodiments in detail, when it is considered that a detailed description on related well-known functions or constitutions unnecessarily may make essential points of the present invention be unclear, the detailed description will be omitted.

In the drawings, the same reference numerals are used throughout to designate the same or similar components.

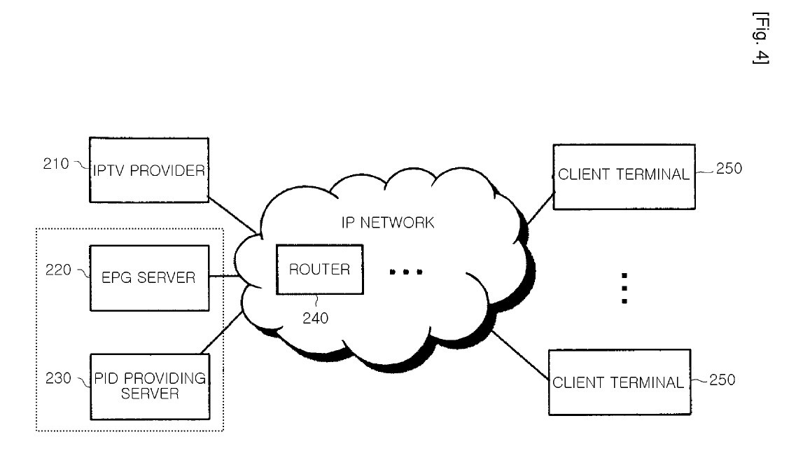

FIG. 4 is a configuration diagram illustrating an Internet protocol television (IPTV) digital broadcast system for reducing a channel change time, according to an exemplary embodiment of the present invention.

Referring to FIG. 4, the IPTV digital broadcast system includes an IPTV providing server 210, an electronic program guide (EPG) server 220, a packet identification (PID) providing server 230, one or more routers 240, and one or more client terminals 250. In this case, the one or more routers 240 form an IP network.

The IPTV providing server 210 manufactures and broadcast data with respect to one or more channels, in a motion picture experts group transport stream (MPEG-TS) type broadcast stream.

The EPG server 220, when the client terminal 250 accesses, acquires an EPG with respect to an IPTV service provided by the system and multicast group information for each channel and provides the EPG and the multicast group information to the client terminal 250 together with PID information for each channel provided by the PID providing server 230.

Also, the EPG server 220, whenever the PID providing server 230 provides the PID information for each channel, additionally provides the provided PID information to the client terminal 250 in such a way that the client terminal 250 always receives newest PID information. Accordingly, the client terminal 250 may receive the newest PID information for each channel via the EPG server 220, thereby always accurately and safely decoding a broadcast stream.

The PID providing server 230 acquires and provides the PID information for each channel with respect to the IPTV service provided by the system, to the EPG server 220.

The PID providing server 230 may acquire the PID information for each channel by periodically joining a multicast group in the IPTV network and acquiring and analyzing a broadcast stream or receiving from an administrator of one of the PID providing server 230 and the IPTV digital broadcast system via manual input.

In this case, the PID information for each channel includes of one or more PID of each of packet forming broadcast data for each channel, such as a video PID, an audio PID, a digital rights management (DRM) PID, a conditional access system (CAS) PID, entitlement management messages (EMM) and entitlement control message (ECM) PID of a CAS, and other option PIDs.

The router 240, when the client terminal 250 request joining a certain multicast group, allows the client terminal 250 to join the multicast group,and copies and transfers a broadcast stream of the multicast group to the client terminal 250 in response to the requesting.

The client terminal 250 receives and stores an EPG, multicast group information for each channel, and PID information for each channel provided by the EPG server 220 when accessing the IPTV network. When a user changes a channel by using the EPG, multicast group information and PID information of the changed channel are searched from the multicast group information for each channel and the PID information for each channel, and the client terminal 250 joins a multicast group corresponding to the changed channel via the multicast group information of the changed channel. When a transmission of a broadcast stream starts, the broadcast stream is decoded via the PID information of the changed channel and broadcast data of the changed channel is extracted and replayed.

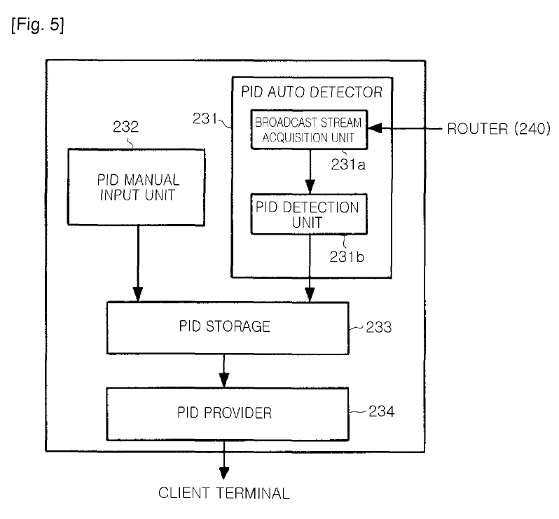

FIG. 5 is a configuration diagram illustrating the PID providing server 230 in detail.

Referring to FIG. 5, the PID providing server 230 includes a PID auto detector 231, a PID manual input unit 232, a PID storage 233, and a PID provider 234.

The PID auto detector 231 includes a broadcast stream acquisition unit 231a and a PID detection unit 231b and detects PID information of a changed channel from a broadcast stream transmitted via an IP network. For this, the broadcast stream acquisition unit 231a, when a client terminal changes a channel, joins a multicast group corresponding to the changed channel and acquires a broadcast stream of the changed channel. The PID detection unit 231b confirms a program map table (PMT) of the changed channel by acquiring and analyzing a program association table (PAT) from the acquired broadcast stream and acquires PID information for each channel by extracting a PID for each channel.

The PID manual input unit 232 acquires the PID information for each channel manually inputted by an administrator of one of an IPTV digital broadcast system and the PID providing server 230.

The PID storage 233 stores and updates the PID information for each channel, acquired via one of the PID auto detector 231 and the PID manual input unit 232.

The PID provider 234, whenever a setting period comes or PID information is changed, transmits the PID information stored in the PID storage 233 to the EPG server 220.

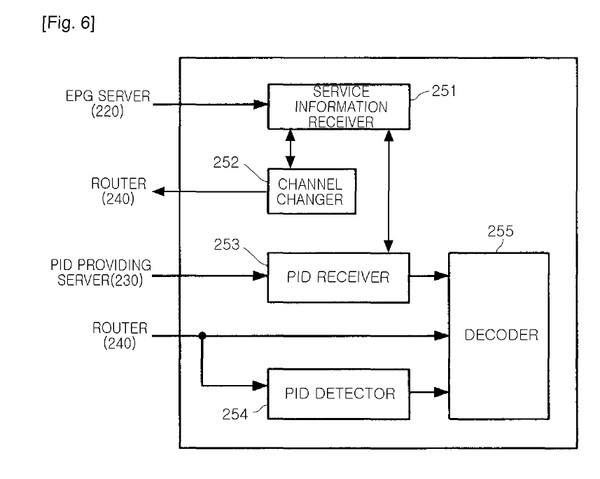

FIG. 6 is a diagram illustrating a client terminal according to an exemplary embodiment of the present invention.

Referring to FIG. 6, the client terminal includes a service information receiver 251, a channel changer 252, a PID receiver 253, a PID detector 254 and a decoder 255.

The service information receiver 251, to receive an IPTV service, accesses the EPG server 220 and receives and stores an EPG, multicast group information for each channel, and PID information for each channel from the EPG server 220.

The channel changer 252, whenever a user changes a channel via the EPG, acquires multicast group information of a changed channel from multicast group information for each channel and requests joining a multicast group corresponding to the changed channel, that is, a transmission of a broadcast stream corresponding to the changed channel.

The PID receiver 253, whenever the user changes the channel via the EPG, acquires PID information of the changed channel from the PID information for each channel and provides the acquired PID information to the decoder 255.

The PID detector 254 acquires a PMT of the changed channel from a PAT by receiving and analyzing the broadcast stream transmitted from the router 240 similarly to a conventional method and acquires PID information of the changed channel from the PMT of the changed channel.

The decoder 255, when a broadcast stream is transmitted from the router 240, decodes the broadcast stream via the PID information provided by the PID receiver 253 and extracts and replays broadcast data of the changed channel. When the PID receiver 253 abnormally operates, the decoder 255 receives the PID information from the PID detector 254 and decodes the broadcast stream.

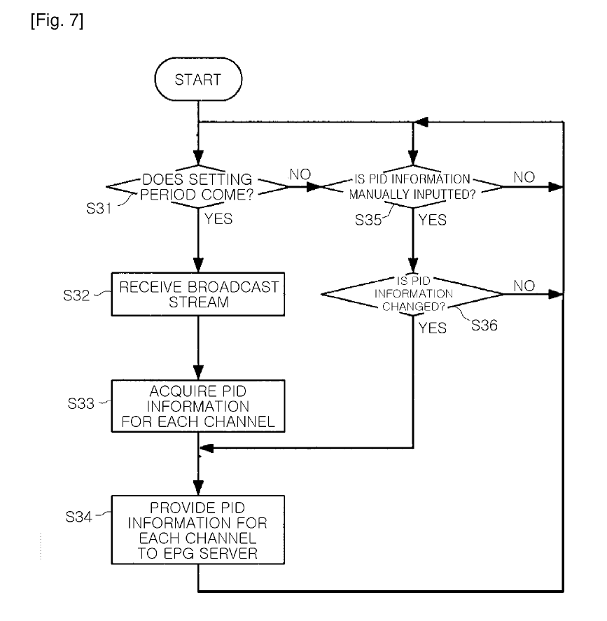

FIG. 7 is a flowchart illustrating a method of providing PID information in a PID providing server, according to an exemplary embodiment of the present invention.

When a setting period comes (S31), a broadcast stream is received by joining a multicast group in an IPTV network (S32).

PID information for each channel is acquired by analyzing the received broadcast stream (S33) and is provided to the client terminal 250 currently accessing (S34). Return to S31, whenever the setting period comes, the PID information for each channel is redetected and retransmitted to the client terminal 250.

Also, it is checked whether the PID information for each channel is manually inputted by an administrator of one of an IPTV digital broadcast system and the PID providing server (S35). When PID information of a changed channel is manually inputted, it is further checked whether the PID information is changed (S36).

As a result of the checking of S36, when there is checked changed PID information, S34 is performed again in such a way that the PID information for each channel is immediately transmitted to the EPG server 220.

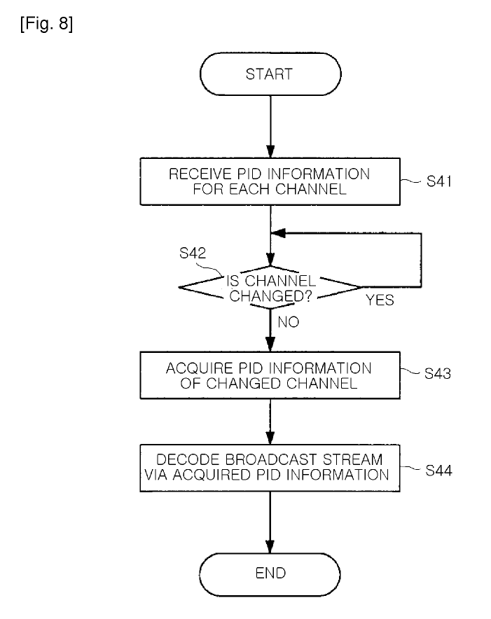

FIG. 8 is a flowchart illustrating a decoding method in the client terminal 250, according to an exemplary embodiment of the present invention.

The client terminal 250 receives the PID information for each channel provided via the process of FIG. 7 (S41).

In this case, when a channel is changed by a user (S42), the client terminal 250 acquires PID information of the changed channel from the PID information for each channel (S43).

A broadcast stream transmitted from the router 240 is decoded by using the PID information acquired via S43 and broadcast data of the changed channel is extracted and replayed (S44).

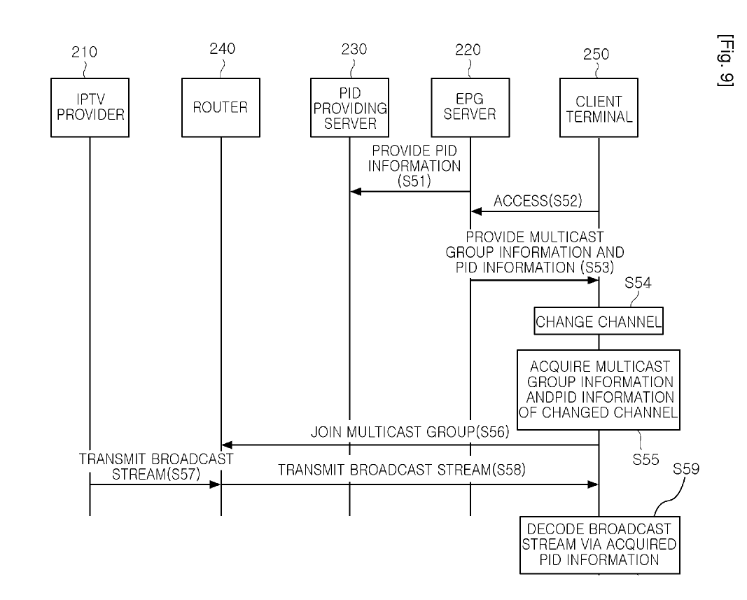

FIG. 9 is a flowchart illustrating a channel change method in an IPTV digital broadcast system, according to an exemplary embodiment of the present invention.

The PID information server 230, whenever a setting period comes or there is changed information, acquires PID information for each channel and provides the acquired information to the EPG server 220 (S51).

In this case, when the client terminal 250 accesses the EPG server 220 to receive an IPTV service (S52), the EPG server 220 provides an EPG of its own, multicast group information for each channel, and PID information for each channel provided by the PID information server 230, to the client terminal 250 (S53).

When a user of the client terminal 250 changes a channel via the EPG (S54), the client terminal 250 acquires multicast group information and PID information corresponding to the changed channel by searching the received multicast group information for each channel and PID information for each channel (S55). The client terminal 250 requests the router 240 to allow the client terminal to join a multicast group corresponding to the changed channel by using the acquired multicast group information (S56).

Then, the router 240, after checking whether it is possible that the client terminal 250 joins the multicast group via the multicast group information, allows the client terminal 250 to join the multicast group and copies and transfers a broadcast stream transmitted in the multicast group, to the client terminal 250 (S57 and S58).

The client terminal 250 receiving the broadcast stream transmitted from the router 240 decodes the broadcast stream by using the PID information acquired in S56 as shown in FIG. 8 and extracts and replays broadcast data of the changed channel (S59).

As described above, the client terminal 250 of FIG. 9, after previously receiving the PID information of the changed channel via the additional PID providing server, decodes the broadcast stream as shown in FIG. 8, thereby minimizing a delay time occurring when changing a channel.

Though the EPG server and the PID providing server are separated from each other in the present embodiment, the EPG server and the PID providing server may be integrated into one service information providing server or a PID providing server of a conventional EPG server may include functions of the PID providing server.

While the present invention has been shown and described in connection with the exemplary embodiments, it will be apparent to those skilled in the art that modifications and variations can be made without departing from the spirit and scope of the invention as defined by the appended claims.

1. A client terminal comprising:
a service information receiver receiving multicast group information for each channel and PID (packet identification) information for each channel, transmitted from an IPTV (Internet protocol television) network;
a channel changer, when a channel is changed, acquiring multicast group information of the changed channel from the multicast group information for each channel and joining a multicast group;
a PID searcher, when a channel is changed, searching the PID information for each channel and acquiring PID information of the changed channel; and
a decoder, when a broadcast stream transmitted to the multicast group is received, decoding the broadcast stream via the PID information of the changed channel.

2. The client terminal of claim 1, further comprising a PID detector detecting the PID information by analyzing the broadcast stream.

3. The client terminal of claim 2, wherein the decoder, when the PID receiver abnormally operates, decodes the broadcast stream via the PID information detected by the PID detector.

4. The client terminal of claim 1, wherein the PID information for each channel comprises one or more of a video PID, an audio PID, a DRM (digital rights management) PID, a CAS (conditional access system) PID, PID on EMM (entitlement management messages) and ECM (entitlement control message) of a CAS, and other options PID, which correspond to each of a plurality of channels and form the correspondent channel.

5. A PID providing server comprising:
a PID auto detector joining an IPTV network, acquiring a broadcast stream, and detecting PID information for each channel from the broadcast stream;
a PID manual input unit for manually inputting the PID information for each channel; and
a PID provider providing the PID information for each channel acquired by one of the PID auto detection and the PID manual input unit, to an EPG (electronic program guide) server.

6. The PID providing server of claim 5, wherein the PID auto detector comprises:
a broadcast stream acquisition unit joining a multicast group in the IPTV network and acquiring the broadcast stream; and
a PID detection unit detecting the PID information by analyzing the broadcast stream.

7. The PID providing server of claim 5, wherein the PID provider, whenever a setting period comes or the PID information for each channel is changed, further comprises reacquiring the PID information for each channel and retransmitting the PID information to the EPG server.

8. The PID providing server of claim 5, wherein the PID information for each channel comprises one or more of a video PID, an audio PID, a DRM PID, a CAS PID, PID on EMM and ECM of a CAS, and other options PID, which correspond to each of a plurality of channels and form the correspondent channel.

9. An IPTV digital broadcast system comprising:
an IPTV providing server providing a broadcast stream including broadcast data for each channel;
an EPG server, when a client terminal accesses, providing an EPG, multicast group information for each channel, and PID information for each channel to the client terminal; and
a PID providing server acquiring the PID information for each channel itself and providing the PID information for each channel to the EPG server.

10. The IPTV digital broadcast system of claim 9, wherein the PID providing server comprises:
a PID auto detector joining a multicast group in IPTV network, acquiring a broadcast stream from the joined multicast group, and detecting PID information for each channel from the broadcast stream;
a PID manual input unit for manually inputting the PID information for each channel; and
a PID provider providing the PID information for each channel acquired by one of the PID auto detector and the PID manual input unit, to an EPG (electronic program guide) server.

11. The IPTV digital broadcast system of claim 10, wherein the PID provider, whenever a setting period comes or the PID information for each channel is changed, further comprises reacquiring the PID information for each channel and retransmitting the PID information to the EPG server.

12. A method of changing a channel of an IPTV digital broadcast system formed of an IPTV providing server, a service information providing server, and a client terminal, the method comprising:
providing multicast information for each channel and PID information for each channel when sensing an access of the client terminal, performed by the service information providing server;
acquiring multicast information and PID information of a changed channel from the multicast information for each channel and the PID information for each channel when a channel is changed, performed by the client terminal;
requesting receiving a broadcast stream provided by the IPTV providing server via the multicast information of the changed channel, performed by the client terminal; and
receiving the broadcast stream and decoding the received broadcast stream via the PID information of the changed channel, performed by the client terminal.

13. The method of claim 12, wherein the providing multicast information for each channel and PID information for each channel comprises:
acquiring the PID information for each channel; and
providing the PID information for each channel together with the multicast group information for each channel.

14. The method of claim 13, wherein the acquiring the PID information for each channel comprises:
joining the IPTV network and acquiring the broadcast stream; and
detecting the PID information for each channel by analyzing the broadcast stream.

15. The method of claim 14, wherein the acquiring the PID information for each channel further comprises reacquiring the broadcast stream and redetecting and retransmitting the PID information for each channel whenever a setting period comes.

16. The method of claim 14, wherein the acquiring the PID information for each channel further comprises manually inputting the PID information for each channel and retransmitting the PID information for each channel when the PID information for each channel is changed.

17. The method of claim 12, wherein the PID information comprises one or more of a video PID, an audio PID, a DRM PID, a CAS PID, PID on EMM and ECM of a CAS, and other options PID, which correspond to each of a plurality of channels and form the correspondent channel.
